(19) United States
(12) Patent Application Publication
(10) Pub. No.: US 2013/0166905 A1
(43) Pub. Date: Jun. 27, 2013

(54) METHODS AND ARRANGEMENTS FOR SECURE COMMUNICATION OVER AN IP NETWORK

(71) Applicants: Per Wollbrand, Stockholm (SE); Malin Jonsson, Bandhagen (SE); Pal Dammvik, Arsta (SE)

(72) Inventors: Per Wollbrand, Stockholm (SE); Malin Jonsson, Bandhagen (SE); Pal Dammvik, Arsta (SE)

(73) Assignee: TELEFONAKTIEBOLAGET L M ERICSSON (PUBL), Stockholm (SE)

(21) Appl. No.: 13/818,599

(22) PCT Filed: Aug. 25, 2010
(86) PCT No.: PCT/SE2010/050914

§ 371 Date: Mar. 13, 2013

(51) Int. Cl. H04L 29/06

(52) U.S. Cl. CPC H04L 63/0428
USPC 713/151

(57) ABSTRACT

The embodiments of the present invention relate to a method in a transmitting node; a method in a receiving node; a transmitting node and a receiving node in an IP network employing Internet security. The receiving node comprises a Receiving Unit, a Processing Unit and a Transmitting Unit. When an IP packet is received, the Processing Unit is adapted to derive a Security Association and a Traffic Class associated with the IP packet. The Processing unit is also adapted to maintain one anti-replay window for each Traffic Class within the Security Association and to determine if a sequence number of the IP packet is within the anti-replay window of the Traffic Class and is not a duplicate of an earlier received packet. If said sequence number is not within the anti-replay window or is a duplicate of an earlier received packet, the packet is dropped.

### TECHNICAL FIELD

The present invention relates generally to methods and arrangements for communicating data over an Internet Protocol network. The present invention relates in particular to a method and an apparatus for communicating data over an IP network employing Internet Protocol Security (IPsec).

### BACKGROUND

When communicating data over an IPsec protected network from a packet sender to a packet receiver, Internet Protocol (IP) Security (IPsec) anti-replay protection is employed as a security service, in which a receiver is provided with the capability of rejecting old or duplicated packets. This is a way of protecting against so-called replay attacks. In short and very simplified, a sender wanting to communicate data over the Internet security network has his/her packets encapsulated in an IPsec packet before the packet is sent over the network. At the receiver, the received encapsulating IPsec packet is processed in order to access the packet within.

The sender applies a unique Sequence Number (SN) to the IPsec header of the packets sent within an IPsec Security Association (SA). Thus, a SA is associated with each sent or received packet. A SA can be viewed as an agreement between two devices e.g. a sender and a receiver, about how to protect information during transit.

As mentioned, the sender applies a unique SN to the IPsec header of packets sent within an (agreed) IPsec SA. The sender assigns SNs in an increasing order. The receiver remembers the value of the SNs of the packets it has already received. In case the receiver receives an IP packet having the same SN for a specific SA as a previously received packet, the packet is discarded or dropped as being a fake or bad packet. This is because the receiver determines that it has already seen that SN and therefore the packet is dropped. This is known as IPsec anti-replay protection in which the receiver may reject old or duplicate packets to protect itself against replay attacks.

This anti-replay protection mechanism is often referred to as sliding window based anti-replay protection. Briefly described, a packet having a Sequence Number contained in the (sliding) window of a certain size is accepted, otherwise rejected or dropped to protect against replay.

However, when Quality-of-Service (QoS) prioritization based on the Differentiated Services Code Point (DSCP) within the IP packet header, is introduced, some packets may be subjected to queuing at different network elements, thereby disrupting the sequence of packets being sent over the Internet security network. This will cause “newer” packets to arrive at the receiver before “older” packets arrive. This will disturb the sequence number ordering for when the packets are received. As a consequence, the anti-replay mechanism may discard or drop genuine older packets as mistaken for being fake or bad packets.

In order to overcome this problem, RFC 4301 from IETF (Internet Engineering Task Force) proposes to setup separate IPsec SAs per DSCP or set of DSCPs within a certain set of traffic selectors. A traffic selector comprises source IP addresses, destination IP addresses, protocol, source ports and destination ports. However, the number of SAs might be a limited resource and thus a peer may refuse to setup additional SAs.

Another approach addressing this problem introduces separate anti-replay windows per sets of DSCP values, in addition to a global anti-replay window for the IPsec SA. The global anti-replay window must be large enough to accommodate all packets in one sequence. In order to ascertain if a received packet is a “good” packet, the received packet is firstly pre-processed, to access the encapsulated packet within the received IPsec packet. This is performed in order to retrieve the DSCP of the inner IP header i.e. the DSCP that is associated with the received packet. Then post-processing is applied to determine if the received packet should be kept or discarded.

However, this approach requires a very large global anti-replay window in order to be able to hold all packets in a sequence. It might not even be possible to maintain such a large anti-replay window, depending on available system resources. Further, this approach requires both pre-processing, decryption and post processing before the anti-replay processing is finalized. This is resource consuming. Further, the queuing of packets in the network that is causing the problem for the anti-replay protection is based on the DSCP value of the outer header. Since this approach uses the DSCP value in the inner header for selection of anti-replay window, it is not guaranteed to work in networks where the outer DSCP value differs from the inner.

### SUMMARY

It is an object of the exemplary embodiments of the present invention to address at least some of the problems outlined above. In particular, it is an object of the exemplary embodiments of the present invention to provide anti-replay protection with a minimized number of Security Associations, which in turn reduces the use of system resources.

These objects and others may be obtained by providing a method in a transmitter and a method in a receiver as well as a transmitting node and a receiving node.

According to an aspect, a method in a transmitter is provided for communicating data over an Internet Protocol (IP) network employing Internet security. The method comprises receiving an IP packet, to be transmitted over the IP network and deriving a Security Association (SA) associated with the received IP packet. The method further comprises deriving a Differentiated Services Code Point value (DSCP value) associated with an outer IP packet and encapsulating the received IP packet into the outer IP packet, wherein the outer IP packet comprises an IP header and an Encapsulating Security Payload header (ESP header). Further, the method comprises inserting the DSCP value into the IP header of the outer IP packet and deriving a Traffic Class from the DSCP value and the SA. The method further comprises incrementing a Sequence Number, SN, dedicated for the Traffic Class within the SA, and inserting the incremented SN and the Traffic Class into the outer IP packet.

By doing this, the number of Security Associations can be minimized, which in turn reduces the use of system resources.

Yet an advantage is that the size of the anti-replay window, at the receiver can be minimized, since separate anti-replay windows are maintained for each Traffic Class within a Security Association. This also reduces the use of system resources.

Further, as a consequence of the reduced number of Security Associations, faster end-to-end network recovery can be obtained.

According to an embodiment of the method in a transmitter, inserting the incremented SN and the Traffic Class into the outer IP packet comprises inserting the incremented SN and said Traffic Class in the ESP header of the outer IP packet.

This has the advantage that the SN and Traffic Class will be integrity protected and hence protected from being tampered with. This has the advantage that the Traffic Class of the ESP header can be trusted by the receiving party. The integrity protection comprises computing an Integrity Check Value (ICV) over the ESP packet, using an integrity algorithm.

According to an aspect, a method in a receiver is provided of communicating data over an Internet protocol (IP), network employing Internet security. The method comprises receiving an IP packet, comprising an Encapsulating Security Payload (ESP) header. The method further comprises deriving a Security Association (SA), and a Traffic Class, associated with the received IP packet, the Traffic Class being derived from the ESP header and maintaining one anti-replay window for each Traffic Class within the SA. Further, the method comprises determining if a Sequence Number, SN, in the ESP header is within the anti-replay window of the Traffic Class and is not a duplicate of an earlier received packet. If the sequence number is within the anti-replay window and is not a duplicate of an earlier received packet, then the method comprises processing the received IP packet.

By maintaining one anti-replay window per Traffic Class, the anti-replay window can be very small. This is because packets within one anti-replay window will not be reordered by Quality-of-Service handling in the network. For example, the window size can be limited to one packet.

According to an embodiment of the method in a receiver, the method comprises dropping the received packet if the SN of the ESP header is not within the anti-replay window of the Traffic Class or is a duplicate of an earlier received packet.

According to an aspect, a transmitting node in an IP network employing Internet security is provided. The transmitting node comprises a Receiving Unit adapted to receive an IP packet comprising an ESP header. The transmitting node further comprises a Processing Unit adapted to derive a Security Association (SA) associated with the received IP packet and a Differentiated Services Code Point (DSCP) value associated with an outer IP packet. The processing Unit of the transmitting node is further adapted to encapsulate the IP packet into the outer IP packet, the outer IP packet comprising an IP header and an Encapsulating Security Payload (SP) header. The processing Unit of the transmitting node is further adapted to insert the DSCP value into the IP header of the outer IP packet; and to derive a Traffic Class from the DSCP value and the SA. The processing Unit of the transmitting node is further adapted to increment a Sequence Number (SN) dedicated for the Traffic Class within the SA and to insert the incremented SN and the Traffic Class into the outer IP packet. The transmitting node further comprises a Transmitting Unit adapted to transmit the outer IP packet towards a destination receiving node.

According to an embodiment, the Processing Unit is adapted to insert the incremented SN and the Traffic Class in the ESP header of the outer IP packet.

According to an aspect, a receiving node in an IP network employing Internet security is provided. The receiving node comprises a Receiving Unit adapted to receive an IP packet comprising an ESP header. The receiving node further comprises a Processing Unit adapted to derive a Security Association (SA) and to derive a Traffic Class associated with the received IP packet from the ESP header. The Processing unit further being adapted to maintain one anti-replay window for each Traffic Class within the SA; and determine if a sequence number in the ESP header is within the anti-replay window of the Traffic Class and is not a duplicate of an earlier received packet, wherein if the sequence number is within the anti-replay window and is not a duplicate of an earlier received packet, then processing the received packet. The receiving node further comprises a Transmitting Unit adapted to forwarding an encapsulated IP packet comprised within the received IP packet to its destination as indicated in an IP header of the encapsulated IP packet.

According to an embodiment of the receiving node, the Processing Unit is adapted to, if the SN of the ESP header is not within the anti-replay window of the Traffic Class or is a duplicate of an earlier received packet, drop the received packet.

### BRIEF DESCRIPTION OF DRAWINGS

The invention will now be described in more detail by means of exemplary embodiments and with reference to the accompanying drawings, in which:

FIG. 1 is a schematic overview of a sender and receiver communicating over an IP network employing Internet security.

FIG. 2 is a flow chart of an embodiment of a method in a transmitting node of communicating data over an IP network employing Internet security.

FIG. 3 is a flow chart of an embodiment of a method in a receiving node of communicating data over an IP network employing Internet security.

FIG. 4-6 are schematic illustrations of different embodiment of an ESP header.

FIG. 7 is a block diagram illustrating a transmitting node in an IP network employing Internet security according an embodiment.

FIG. 8 is a block diagram illustrating a receiving node in an IP network employing Internet security according an embodiment.

FIG. 9 is a signaling diagram illustrating some of the negotiations regarding an Internet Key Exchange.

FIG. 10 is illustrates an update of the SA Payload to support the method illustrated in FIGS. 2 and 3.

FIG. 11 is a block diagram of a Transform field comprised in an SA Payload

FIG. 12 is a signaling diagram schematically illustrating a part of negations regarding the Internet Key Exchange.

### DETAILED DESCRIPTION

Briefly described, a method and an arrangement in a transmitting node and a receiving node, respectively, are provided for communicating over an IP network employing Internet security. The communication over the IP network employing Internet security comprises encapsulating packets being communicated between an originating node and a terminating node in IPsec packets.

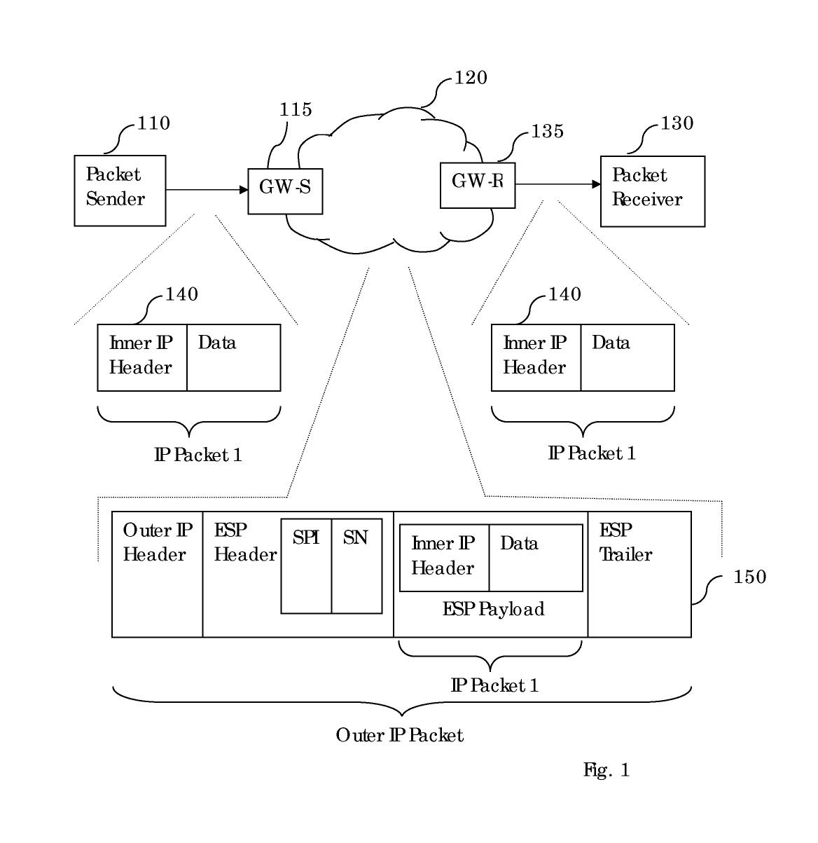

Firstly, communication over an IP network employing IPsec Internet security will be briefly described with reference to FIG. 1.

FIG. 1 discloses a sender 110 and a receiver 130 which represent two parties communicating over an IP network 120 employing IPsec Internet security. It shall be noted that throughout the description, one-way communication is described. The exemplary embodiments of the present invention are not limited to one-way communication. Further, exemplary embodiments are described wherein the packet sender 110 and packet receiver 130 are separate nodes as well as the two respective gateways 115 and 135. It shall be noted that the packet sender 110 can be incorporated into the sending gateway, GW-S, 115 in other embodiments. Likewise, the Packet receiver 130 and the receiving gateway, GW-R, 135 can be incorporated into one node.

In this example, the sender 110 and the receiver 130 are involved in a communication session. The session can comprise communicating one or several packets, normally a plurality of packets are communicated during a session.

For each packet within the session, the sender 110 assigns a DSCP value in order to obtain appropriate QoS characteristics in the network.

As shown in FIG. 1, the packet sender 110 is connected to the IP network 120 via gateway 115. Likewise, the packet receiver 130 is connected to the IP network via gateway 135.

Quite simplified, as the packet sender 110 transmit an IP packet 140 towards the packet receiver 130, the sending gateway, GW-S, 115 encapsulates the IP packet 140 in an outer IP packet 150, also called an IPsec packet. After encapsulating the packet 140 in the outer packet 150, the sending gateway 115 transmit the packet 150 to the receiving gateway, GW-R, 135. The receiving gateway 135 then extract the original packet, i.e. the IP packet 140, from the outer IP packet 150 and forwards the original IP packet 140 to the packet receiver 130.

Encryption and integrity algorithms as well as the Traffic Selectors are described in Security Associations (SAs), which are agreed between the sending gateway 115 and the receiving gateway 135. An SA is in the ESP Header identified by the Security Parameter Index (SPI).

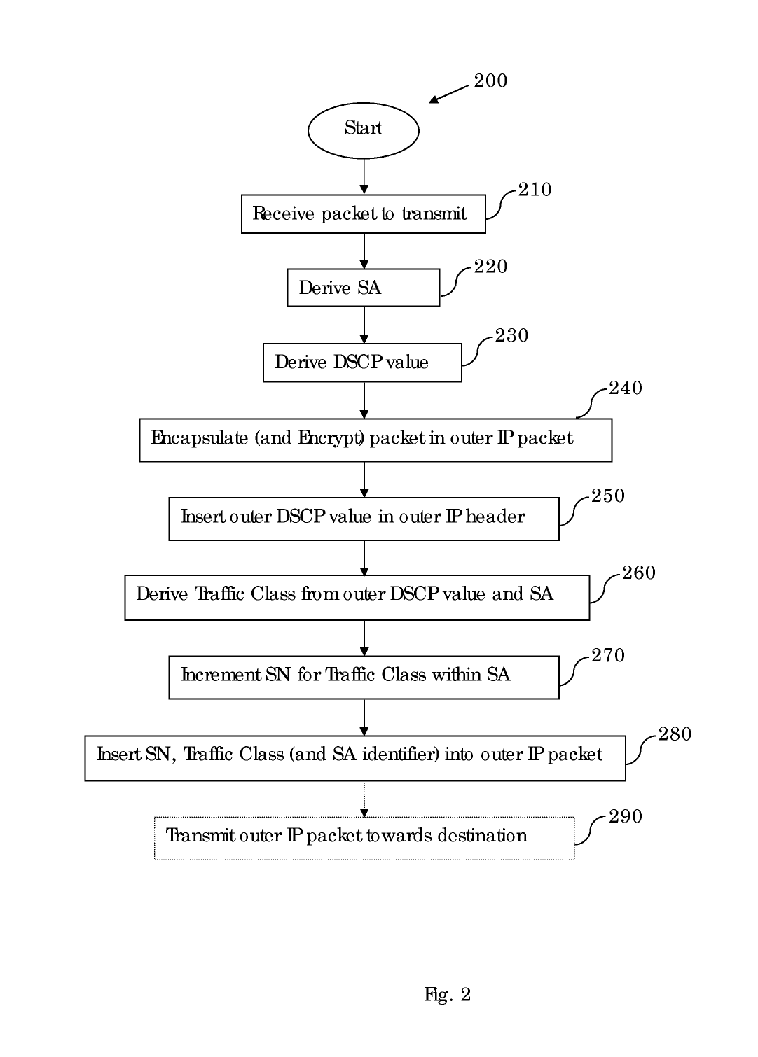

Of course, many different actions are taken at respective gateways 115 and 135 as will be described in more detail below with reference to FIGS. 2-8.

An exemplary embodiment of a method 200 in a transmitting node, e.g. gateway 115, will now be described with reference to FIG. 2. According to this example, the method comprises receiving 210 an Internet Protocol packet, IP packet, to be transmitted over the Internet security network. This packet is also referred to as an inner IP packet. The IP packet comprises an IP header (also called inner IP header) comprising a DSCP field (also called inner DSCP field). In the DSCP field, a DSCP value is placed for the inner IP packet.

The method 200 further comprises deriving 220 a SA associated with the IP packet As described above, the SA is agreed between the sending gateway 115 and the receiving gateway 135. The SA is stored in a SA Database, SAD. The deriving of the SA may therefore be performed by a lookup in the SAD, using an SA identifier comprised in the IP packet.

The method 200 further comprises deriving 230 a DSCP value. This DSCP value is associated with an outer IP packet. Deriving a DSCP value for the outer IP packet can be performed in different ways. One example is to copy the DSCP value of the received IP packet, the inner IP packet, which is to be encapsulated and sent towards the receiving gateway 135. According to another example, a new and, consequently, different DSCP value may be generated by the sending gateway 115.

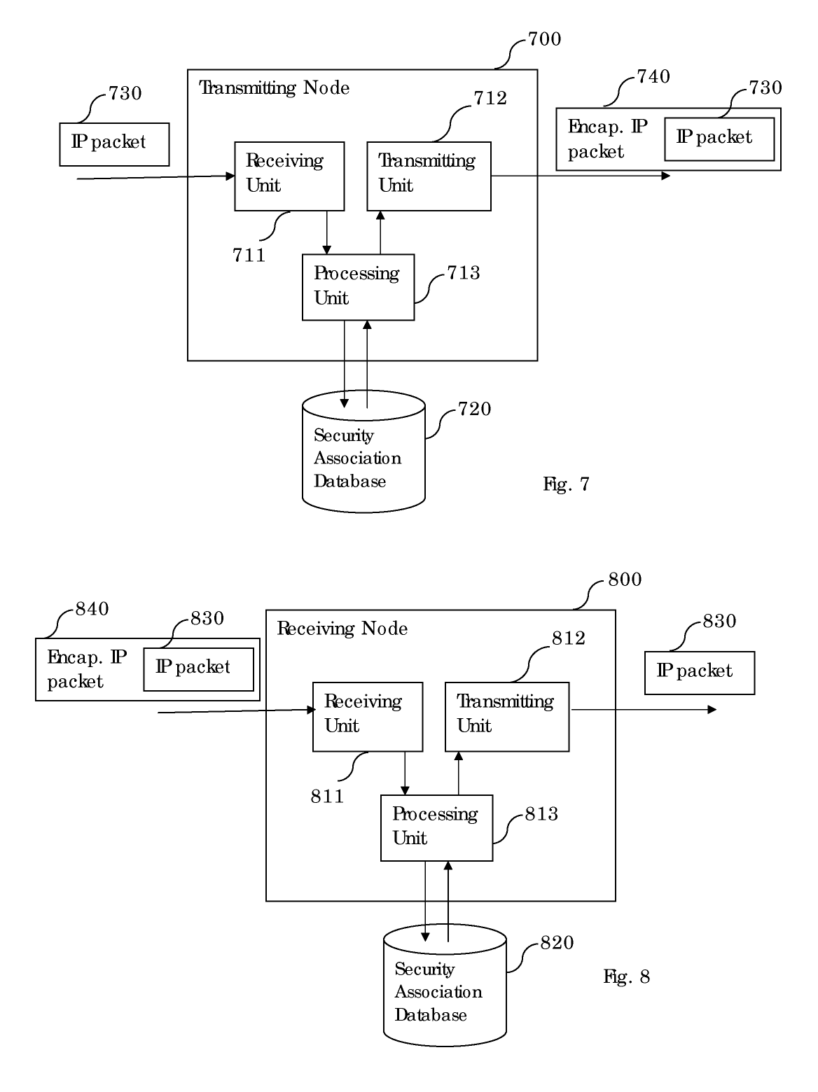

The method 200 further comprises encapsulating 240 the received IP packet into the outer IP packet, the outer IP packet comprising an IP header, also referred to as the outer IP header, and an Encapsulating Security Payload header, ESP header. The outer IP packet also comprises an ESP payload and ESP trailer, wherein the ESP payload comprises the received IP packet, i.e. the inner IP packet. Typically, the received IP packet 730 (see FIG. 7), received by the receiving node 115, is encrypted before it is encapsulated into the outer IP packet 740 (see FIG. 7), although it is conceivable that the IP packet would not be encrypted. Then, as shown in FIG. 2, the method comprises inserting 250 the derived DSCP value into the IP header of the outer IP packet 740. One example of where in the IP header of the outer IP packet to insert the derived DSCP value, is into a DSCP field, referred to as an outer DSCP field of the IP header.

Still further, the method 200 comprises deriving 260 a Traffic Class from the derived DSCP value and the SA. It should be mentioned that within an SA, a Traffic Class identifies a flow of packets, where the packets of the flow are expected not to be reordered by QoS prioritization in the IP network, that is, the sending packet order within the flow is retained. As an example, one Traffic Class could carry real-time traffic (e.g. voice and video) while another Traffic Class could carry best effort traffic (e.g. web browsing).

The method further comprises incrementing 270 the Sequence Number, SN, dedicated for the Traffic Class within the SA.

Then, the SN and Traffic Class are inserted 280 into the outer IP packet 740.

One advantage with this approach is that the number of Security Association can be minimized, which in turn reduces the use of system resources.

Yet an advantage is that the size of the anti-replay window, at the receiver can be minimized, since separate anti-replay windows are maintained for each Traffic Class within a Security Association. This also reduces the use of system resources. This will be described later.

Further, as a consequence of the reduced number of Security Associations, faster end-to-end network recovery can be obtained.

Referring back to FIG. 2, according to an embodiment, the method 200 comprises inserting 280 the SN and the Traffic Class into the ESP header of the outer IP packet.

This has the advantage that the SN and Traffic Class will be integrity protected as the ESP header is integrity protected.

By inserting the Traffic Class into the ESP header, the Traffic Class is protected from being tampered with. This has the advantage that the Traffic Class of the ESP header can be trusted by the receiving party as will be described in more detail below.

Still further, the method 200 comprises inserting SA identifier into the ESP header of the outer IP packet 740. As will be described, this will enable the receiving node to derive the SA.

The SA identifier for the SA can be inserted into, e.g., a Security Parameter Index field (SPI field) in the ESP header and the SN can be inserted into, e.g., a Sequence Number field, SN field in the ESP header.

Further, the method 200 comprises transmitting 290 the outer IP packet 740 towards a destination receiving node.

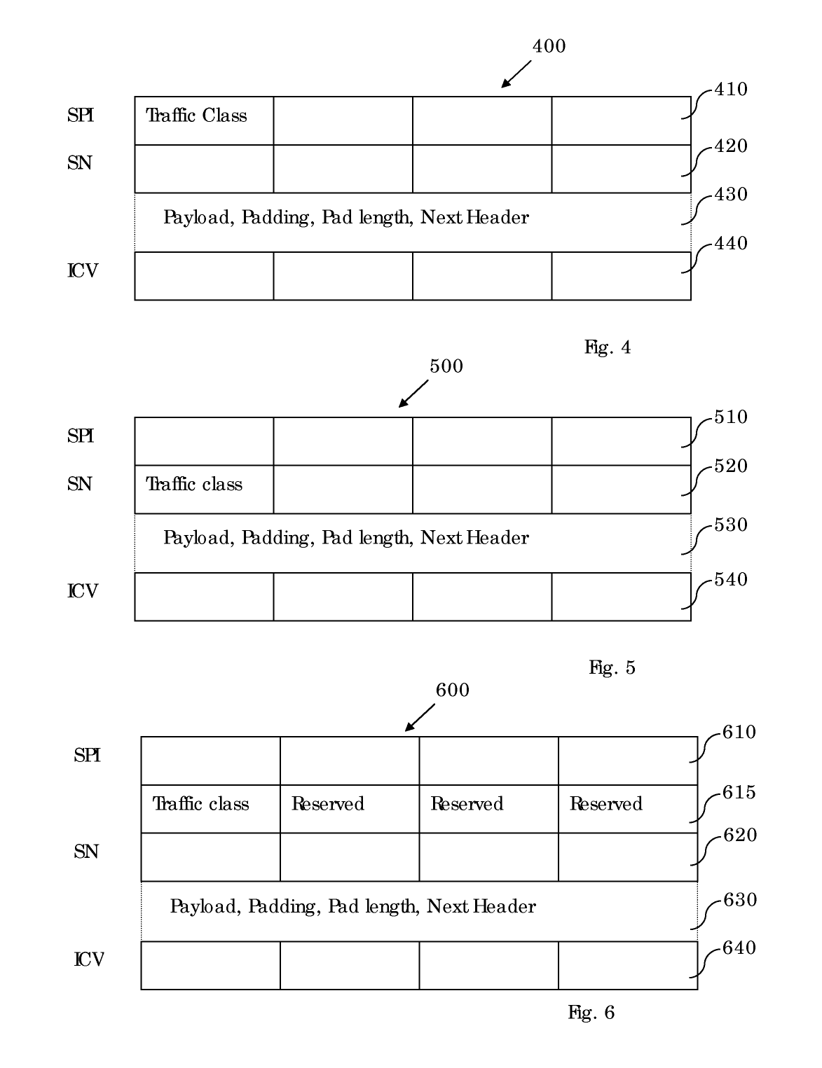

The insertion of the Traffic Class into the ESP header can be done in different ways. According to an example, see FIG. 4, the Traffic Class is inserted into the ESP header 400 in a part of the SPI field 410 of the ESP header. The SPI field is typically 32 bits and in this example, 8 bits of the SPI field are reserved for the Traffic Class.

According to an example, see FIG. 5, the Traffic Class is inserted into the ESP header 500 in a part of the SN field 520 of the ESP header. Just as the SPI field, the SN field is typically 32 bits and in this example, 8 bits of the SN field are reserved for the Traffic Class.

According to yet an example, see FIG. 6, the Traffic Class is inserted into the ESP header 600 in a dedicated field 615 of the ESP header. In this example, the ESP header is updated to comprise a new added dedicated field intended to hold the Traffic Class.

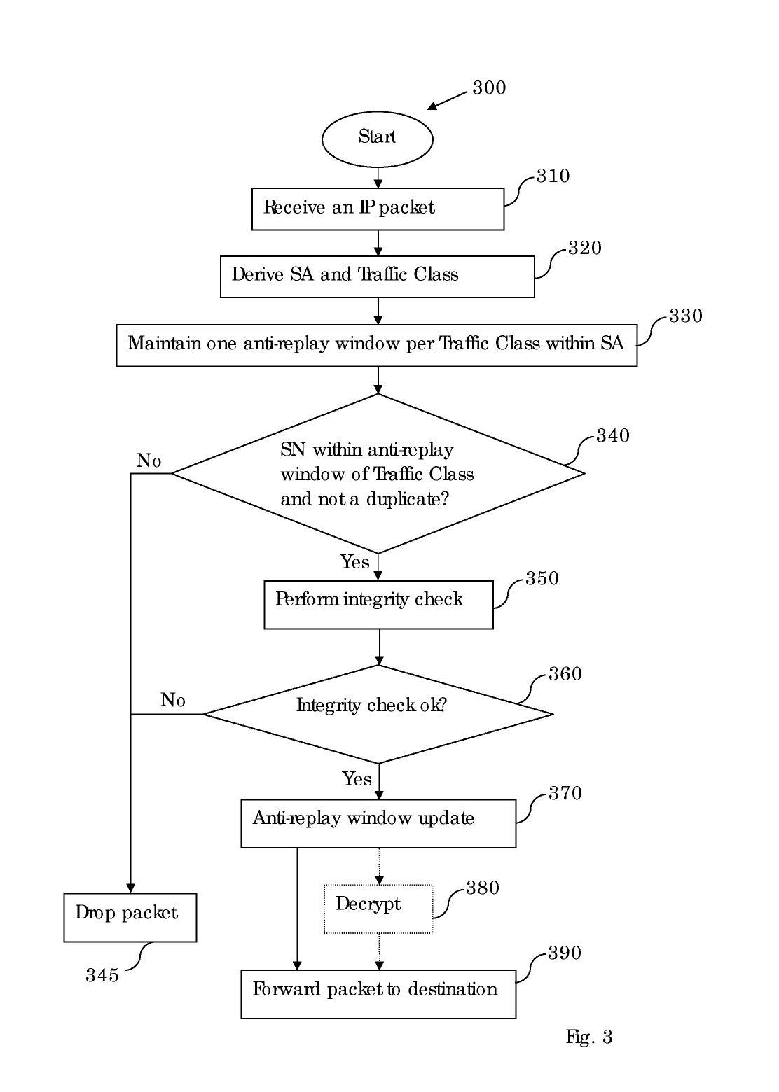

Turning now to FIG. 3, which is a flow chart of an embodiment of a method 300 in a receiving node, e.g. gateway 135, of communicating data over an IP network employing Internet security.

FIG. 3 illustrates first receiving 310 an IP packet 840 (see FIG. 8), also referred to as an outer IP packet. This received IP packet 840 or outer IP packet comprises an inner, encapsulated IP packet 830 in accordance with the method in a transmitting node as described above. The received IP packet can be viewed as an encapsulating IP packet. The method further comprises deriving 320 a Security Association, SA, by using an SA identifier in an Encapsulating Security Payload header, ESP header, of the encapsulating IP packet, to retrieve an SA from an SA Database, and also deriving a Traffic Class.

The SA identifier may be comprised in a Security Parameter Index field, SPI field, of the ESP header. The Traffic Class is comprised in a field in the ESP header of the outer encapsulating IP packet.

The method 300 further comprises maintaining 330 one anti-replay window for each Traffic Class within the SA.

Still further, the method comprises determining 340 if a Sequence Number (SN) of the received IP packet, comprised in the ESP header, is within the anti-replay window of the Traffic Class and is nota duplicate of an earlier received packet. If the SN is within the anti-replay window and is not a duplicate of an earlier received packet, then processing the received packet. The processing may comprise different actions as will be described below.

The sequence number can be comprised in, e.g., a Sequence Number field, SN field, of the ESP header.

As stated before, by inserting the Traffic Class into the ESP header, the Traffic Class is protected from being tampered with. Further, by maintaining one anti-replay window per Traffic Class, the anti-replay window can be very small. This is because packets within one anti-replay window will not be reordered by Quality-of-Service handling in the network. For example, the window size can be limited to one packet. Even though a peer needs to allocate resources to maintain different windows, the resources required are less than the resources to maintain large anti-replay windows.

According to an embodiment of the method, if the SN of the ESP header is not within the anti-replay window of the Traffic Class or is a duplicate of an earlier received packet, the received packet 840 is dropped 345.

In one embodiment, the Traffic Class is derived from a part of a SPI field (410) of the ESP header (400), a part of an SN field (520) or an Extended Sequence Number (ESN) field of the ESP header (500), or a dedicated field (615) of the ESP header (600).

As stated above, if the SN is within the anti-replay window and is not a duplicate of an earlier received packet, then the received IP packet will be further processed. This processing of the received IP packet 840 may for example comprise performing 350 an integrity check of the received IP packet.

Then the integrity check is evaluated 360 and if the integrity check fails to verify the integrity of the encapsulating packet, then the packet is dropped 345.

If the Integrity check verifies the integrity of the packet, then the anti-replay window is updated 370 in accordance with the SN, and the encapsulated IP packet within the encapsulating IP packet is decrypted 380 and the decrypted encapsulated IP packet is forwarded 390 to its destination as indicated in an IP header of the decrypted IP packet. Of course, it is conceivable that the inner IP packet, or the encapsulated packet, is not encrypted. In such a case, it will of course not need to be decrypted 380. Instead, the inner IP packet is forwarded 390 to its destination as indicated in an IP header of the IP packet after the anti-replay window has been updated 370.

FIGS. 4 to 6 are schematic illustrations of different embodiments of an ESP header as previously discussed.

FIG. 4 illustrates an embodiment of an ESP header 400, in which the Traffic Class is comprised in a part of the SPI field 410 of the ESP header. As described above, the SPI field typically comprises 32 bits and in this example, 8 bits are reserved for the Traffic Class.

FIG. 5 illustrates an embodiment of an ESP header 500, in which the Traffic Class is comprised in a part of the SN field 520 of the ESP header. As described above, the SN field typically comprises 32 bits and in this example, 8 bits are reserved for the Traffic Class.

FIG. 6 illustrates an embodiment of an ESP header 600, in which the Traffic Class is comprised in a dedicated field 615 of the ESP header. This dedicated field is added to the ESP header defined in RFC 4303. The dedicated field preferably has 32 bits, wherein e.g. 8 bits are reserved for the Traffic Class.

Depending on the used number of Traffic Classes, all bits of the Traffic Class field might not be used for deriving the Traffic Class.

FIG. 7 is a block diagram illustrating a transmitting node 700 in an IP network employing Internet security and FIG. 8 is a block diagram illustrating a receiving node 800 in an IP network employing Internet security. The transmitting and sending nodes comprise the same or similar objects and advantages as the methods described above and these objects and advantages will not be repeated for simplicity reasons. The transmitting and receiving nodes 700 and 800 comprise different Units as will be described below. These unit may be realized by circuits, which can be software, hardware or a combination thereof.

FIG. 7 illustrates the transmitting node 700 comprising a Receiving Unit 711 adapted to receive an IP packet 730 to be transmitted over the IP network.

The transmitting node 700 further comprises a Processing Unit 713 adapted to derive a Security Association, SA, associated with the received IP packet 730, and a Differentiated Services Code Point value, DSCP value associated with an outer IP packet 740. The processing unit 713 is also adapted to encapsulate the IP packet 730 into the outer IP packet 740, the outer IP packet comprising an IP header, also referred to as an outer IP header, and an Encapsulating Security Payload header, ESP header 400, 500, 600. The processing unit 713 is further adapted to insert the DSCP value into the outer IP header of the outer encapsulating IP packet 740. The processing unit 713 is adapted to derive a Traffic Class from the DSCP value as well as a SA; and to increment a Sequence Number, SN, dedicated for the Traffic Class within the Security Association.

Further, the processing unit 713 is adapted to insert the Sequence Number, SN, and the Traffic Class into the outer encapsulating IP packet 740.

The transmitting node 700 further comprises a Transmitting Unit 712 adapted to transmit the outer IP packet 740 towards a destination receiving node.

In one example, also an SA identifier for the SA for the outer packet 740 is inserted into the outer IP packet 740.

The SA identifier for the SA can be inserted into, e.g., a Security Parameter Index field, SPI field of the ESP header and the SN can be inserted into, e.g., a Sequence Number field, SN field in the ESP header.

According to an embodiment of the transmitting node 700, the Processing Unit 713 is adapted to insert the incremented SN and the Traffic Class in the ESP header 400, 500, 600 of the outer IP packet 740. In one example, the Processing Unit 713 is further adapted to insert the Traffic Class into the ESP header 400 in a part of the SPI field 410 of the ESP header.

In one example, the Processing Unit 713 is further adapted to insert the Traffic Class into the ESP header 500 in a part of the SN field 520 or an ESN field of the ESP header.

In one example, the Processing Unit 713 is further adapted to insert the Traffic Class into the ESP header 600 in a dedicated field 615 of the ESP header.

FIG. 8 illustrates a receiving node 800 comprising a Receiving Unit 811 adapted to receive an IP packet 840. The IP packet 840 comprises an Encapsulating Security Payload header, ESP header, 400, 500, 600. The received IP packet 840 encapsulates an inner IP packet 830, as has been described in conjunction with the transmitting node.

The receiving node 800 further comprises a Processing Unit 813 adapted to derive a Security Association, SA, and to derive a Traffic Class from the ESP header. The Traffic Class is associated with the received packet.

The SA can be derived by using an SA identifier in a Security Parameter Index field, SPI field, of the ESP header of the received, encapsulating IP packet 840, to retrieve an SA from an SA Database, SAD 820.

The processing unit 813 is further adapted to maintain one anti-replay window for each Traffic Class within the SA, and to determine if a sequence number, SN, in the ESP header is within the anti-replay window of the Traffic Class and is not a duplicate of an earlier received packet. If the sequence number is within the anti-replay window and is not a duplicate of an earlier received packet, then the processing unit 813 is adapted to processing the received packet 840.

The receiving node 800 further comprises a Transmitting Unit 812 adapted to forward the encapsulated IP packet 830 towards its destination as indicated in an IP header of the IP packet 830.

According to an embodiment of the receiving node 800, the Processing Unit 813 is adapted to, if the Sequence Number, SN, in the ESP header is not within the anti-replay window of the Traffic Class or is a duplicate of an earlier received packet, drop the received packet 840.

According to an embodiment of the receiving node 800, the Processing Unit 813 is adapted to derive the Traffic Class from a part of the SPI field 410 of the ESP header 400.

According to an embodiment of the receiving node 800, the Processing Unit 813 is adapted to derive the Traffic Class from a part of the SN field 520 of the ESP header 500.

According to an embodiment of the receiving node 800, the Processing Unit 813 is adapted to derive the Traffic Class from a dedicated field 615 of the ESP header 600.

The processing unit 813 can be adapted to perform other tasks and features. As an example, it may be adapted to perform an integrity check of the encapsulating IP packet 840. If the integrity is verified, then the processing unit 813 is adapted to update the anti-replay window in accordance with the SN and to decrypt an encapsulated IP packet 830 within the received IP packet 840, provided the IP packet 830 was encrypted. As has been described above, the inner encapsulated packet 830 need not be encrypted at the transmitting node. As described above, the sequence number can be comprised in a Sequence Number field, SN field, of the ESP header.

In an example, the Processing Unit 813 is further adapted to determine whether the sequence number of the encapsulating IP packet 840 is within the anti-replay window of the Traffic Class and is not a duplicate of an earlier received packet, and if the sequence number is outside the anti-replay window or is a duplicate of an earlier received packet, or, if the integrity check does not verify the integrity, then the Processing Unit 813 is further adapted to drop the encapsulating IP packet 840.

The methods and nodes described above may require updating of the Internet Key Exchange (IKE) protocol. It is proposed to update the IKE protocol such that the capability to support and use the extended ESP packet header is negotiated between two peers. It is also proposed to update the IKE protocol such that the number of supported Traffic Classes can be negotiated between two peers. If this is not negotiated, there will be one Traffic Class per DSCP value.

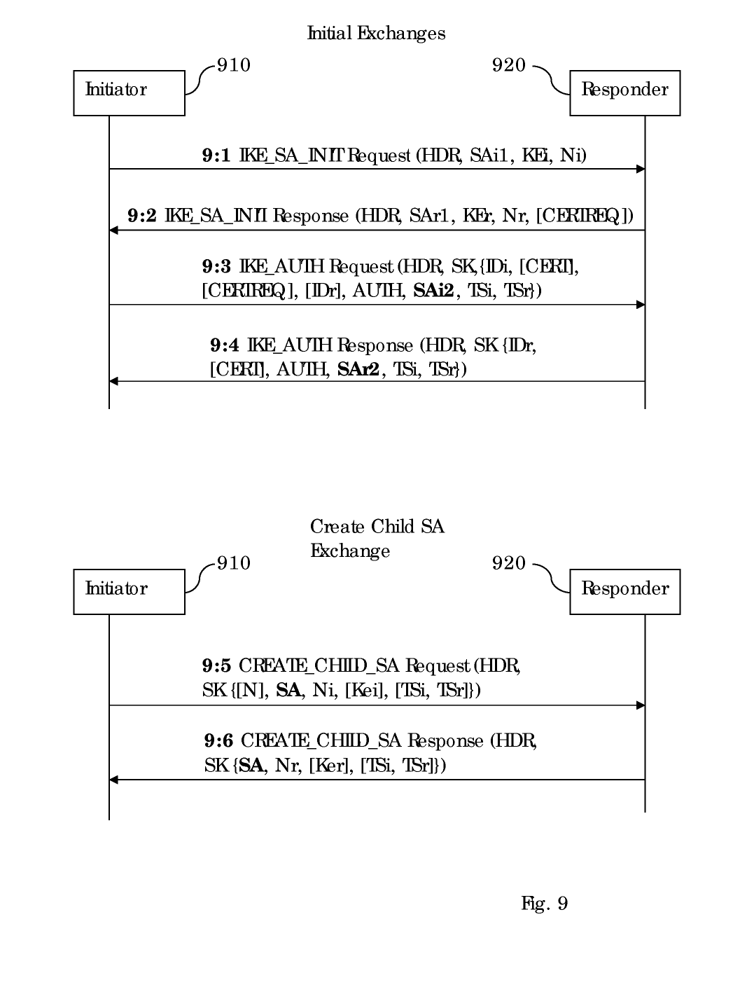

These negotiations may be realized by updating the existing IKE Security Association Init/Auth message as will be described below with reference to FIGS. 9-11.

In general, when a communication session is initiated in most communication networks, some negotiations first take place. With a session is meant any form of communicating, transmitting or exchanging data over a communication network. The negotiations comprises for example negotiating bandwidth, priority, bitrate, protocol to use and so on, of course depending on the kind of session that is to take place.

It should be noted that the figures merely illustrates various functional units of the nodes in a logical sense. However, these functions can be implemented in practice using any suitable software and hardware means or combination thereof. Thus, the invention is generally not limited to the shown structures of the nodes and the functional unit.

FIG. 9 is a signaling diagram illustrating some of the negotiations regarding the Internet Key Exchange (IKE) between an initiator 910 and a responder 920. The initiator 910 may e.g. be the transmitting node 700 of FIG. 7 or gateway 115 of FIG. 1. Likewise, the responder 920 may be the receiving node 800 of FIG. 8 or gateway 135 of FIG. 1. FIG. 9 illustrates the initial exchanges in the negotiations and also the create child SA exchange negotiations.

To start the initial exchanges, the initiator 910 sends 9:1 an IKE_SA INIT_REQUEST, which is an initial request to set up an IKE Security Association (SA) to the responder 920. The initiator 910 encloses in this message, the IKE Header, HDR, which contains the Security Parameter Indexes (SPIs), version numbers and flags of various sorts. The initiator 910 further encloses the SAi1, which states the cryptographic algorithms which are supported by the initiator 910 for the IKE SA. The KEi is also enclosed, comprising the initiator's Diffie-Hellman value and the Ni is also enclosed, which is the initiator's nonce.

The responder 920 sends 9:2 an IKE_SA_INIT Response comprising HDR, SAr1, KEr, Nr and CERTREQ back to the initiator 910. In more detail, the responder 920 chooses a cryptographic suite from the initiator's offered choices and expresses that choice in the SAr1 payload, completes the Diffie-Hellman exchange with the KEr payload, and sends its nonce in the Nr payload. All this is performed as in the IETF REC 4306.

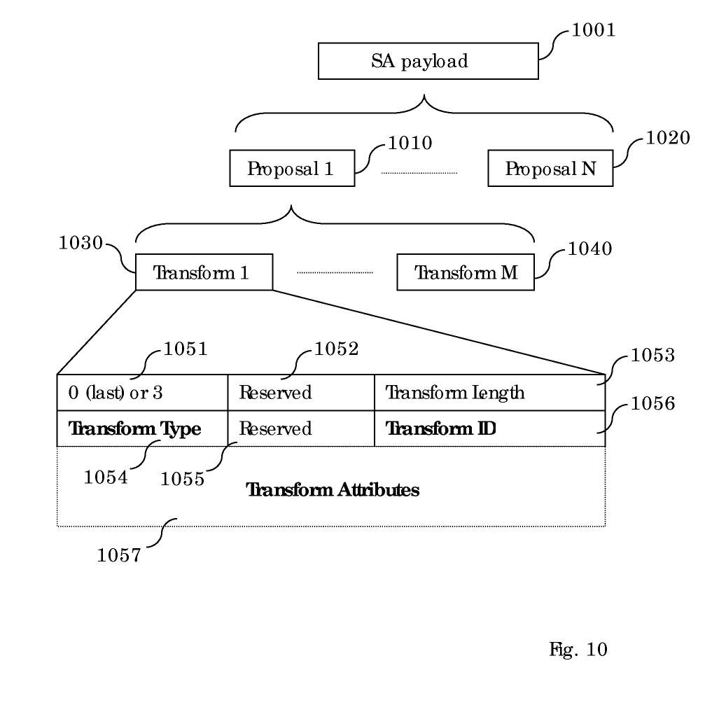

FIG. 9 then illustrates how the initiator 910 sends 9:3 an IKE_AUTH Request comprising HDR, SK, IDi, CERT, CERTREQ, IDr, AUTH SAi2, TSi and TSr to the responder 920. The SK is Security Key, the IDi is the initiator's identity, the CERT is the initiator's certificate(s) and the CERTREQ comprises a list of the initiator's trust anchors. Further the IDr is the responder's identity, the AUTH is used to integrity protect the contents of the first message. The SAi2 is in bold letters in FIG. 9, illustrating that this field will be subjected to an update in order to support the above described methods. The initiator 910 begins negotiation of a CHILD₋SA using the SAi2 payload. The update of SAi2 is illustrated in FIG. 10 and will be described in more detail below. The IKE_AUTH Request also comprises TSi and TSr which are Traffic Selectors for the initiator and responder respectively.

The initial exchanges end by the responder sending 9:4 an IKE_AUTH Response comprising HDR, SK, IDr, CERT, AUTH, SAr2, TSi and TSr. Also here, the SAr2 is in bold letters illustrating that this field with be subject to the same update as the SAi2 above.

For the create child exchange negotiation, FIG. 9 illustrates the initiator 910 sending 9:5 a CREATE_CHILD_SA Request comprising HDR, SK, N, SA, Ni, Ker, TSi and TSr. The N is a Notify field, not to be confused with the previously described Ni and corresponding Nr which are the nonce for the initiator 910 and the responder 920 respectively. Also here, the SA is in bold letters indicating that it is subject to the update as will be described below.

The responder 920 sends 9:6 a CREAT_CHILD_SA Response back to the initiator, the response comprising HDR, SK, SA, Nr, Ker, TSi and TRr. Again, the SA is in bold letters and subject to the update.

Turning now to FIG. 10 which is an illustration of the updates that may be needed in the SA Payload 1001, corresponding to SAi1, SAi2, SAr2 and SA of FIG. 9, in order to support the above described methods.

The SA Payload is used to negotiate attributes of a security association, SA. An SA payload may contain multiple proposals. If there is more than one, they are ordered from most preferred to least preferred. Each proposal may contain multiple IPsec protocols, wherein each protocol may contain multiple transforms, and each transform may contain multiple attributes. Proposals, Transforms, and Attributes each have their own variable length encodings. They are nested such that the Payload length of an SA includes the combined contents of the SA, Proposal, Transform, and Attribute information. The length of a Proposal includes the lengths of all Transforms and Attributes it contains. The length of a Transform includes the lengths of all Attributes it contains.

FIG. 10 illustrates the SA Payload 1001 comprising N number of Proposals 1010-1020 and the first proposal 1010 comprising M number of Transforms 1030-1040. It shall be noted that different proposals may have different number of transforms. FIG. 10 illustrates what. Transform 1 1030 comprises. As can be seen in FIG. 10, Transform Type, Transform ID and Transform Attributes are in bold letters, illustrating that these will be subject to the update(s). Previously, Traffic Class has been described. Traffic Class can be viewed as a transform type. The following Transform IDs could be defined for the transform type Traffic Class: (a) 0—no Traffic Class capabilities, (b) 1—one Traffic Class per DSCP value, and (c) 2—number of Traffic Classes negotiated.

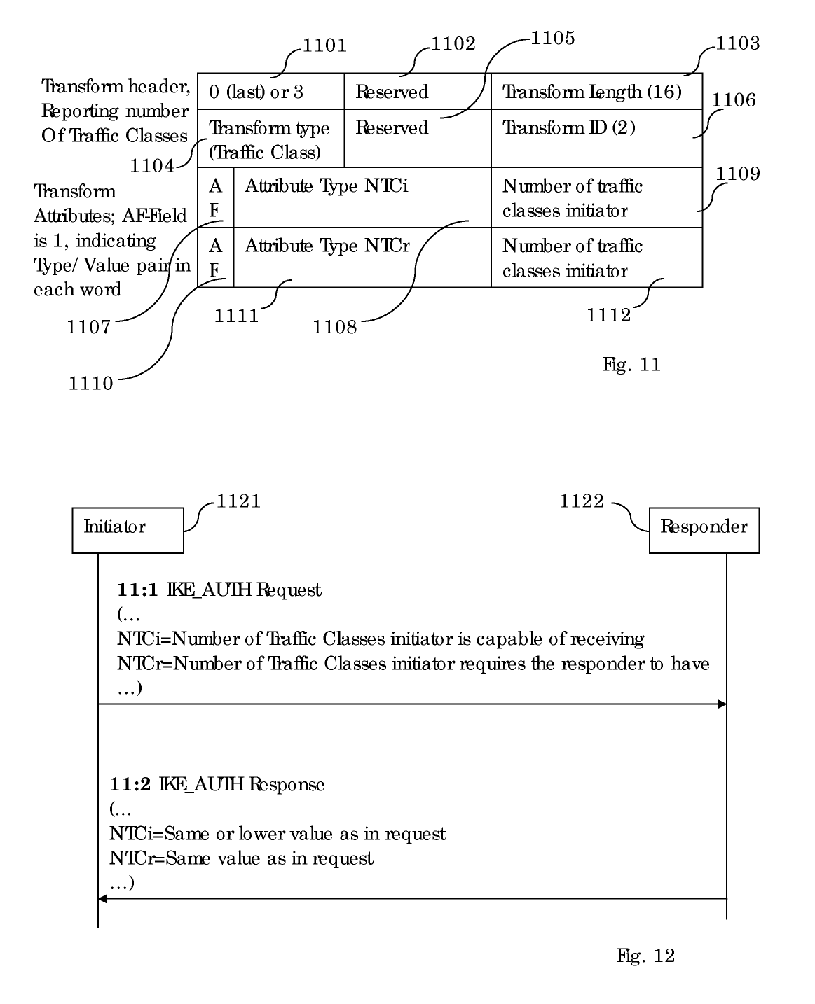

FIG. 11 discloses the Transform ID 2, for which the Transform Attributes include the numbers of Traffic Classes as will be described.

FIG. 11 is a block diagram of a Transform field comprised in an SA Payload and FIG. 12 illustrates a part of the initial IKE message exchange. Again, the initiator 1121 may e.g. be the transmitting node 700 of FIG. 7 or gateway 115 of FIG. 1. Likewise, the responder 1122 may be the receiving node 800 of FIG. 8 or gateway 135 of FIG. 1. The initiator 1121 includes the NTCi attributes 1109, Number of Traffic Classes for the initiator, and the NTCr attributes 1112, Number of Traffic Classes for the responder, in the Traffic Class Transform. The NTCi attribute specifies the number of traffic classes to be used in the direction from the responder to the initiator. Correspondingly, the NTCr attribute specifies the number of traffic classes in the opposite direction.

The initiator 1121 proposes a value of NTCi which matches the number of traffic classes it can receive, and a value of NTCr which matches the number of traffic classes included in its DSCP to Traffic Class mapping function. The proposed NTCi value will in most cases be identical to the number of anti-replay windows that the initiator can handle. The proposal is sent to the responder 1122 in an 11:1 IKE_AUTH Request.

As the responder 1122 receives the proposed values of NTCi and NTCr, it will reject the proposal if (a) the responder does not support a mapping function that includes a number of traffic classes that is at maximum NTCi, or (b) the responder cannot handle the anti-replay function for the number of traffic classes specified by NTCr.

If the responder 1122 accepts the proposal, the NTCi and the NTCr attributes are included in the response signal 11:1 IKE_AUTH Response. The responder 1122 might however reduce the value of NTCi in order to indicate that its mapping function includes a lower number of traffic classes.

The initiator 1121 may include several proposals in the SA payload, each with different values of NTCi and NTCr. This would allow the initiator to specify support for multiple mapping functions, which would facilitate the probability of negotiation convergence.

The present invention and its exemplary embodiments can be realized in many ways. For example, one embodiment of the present invention includes a computer-readable medium having program instructions stored thereon that are executable by a computer or processor of the transmitting and receiving nodes respectively (e.g. gateways 115 and 135) to perform the method steps of the exemplary embodiments of the present invention as previously described and as set forth in the claims.

While the invention has been described with reference to specific exemplary embodiments, the description is generally only intended to illustrate the inventive concept and should not be taken as limiting the scope of the invention. The present invention is defined by the appended claims.

1. A method in a transmitting node, of communicating data over an Internet Protocol (IP) network employing Internet security, comprising:
receiving an IP packet, to be transmitted over said IP network;
deriving a Security Association( SA) associated with said received IP packet;
deriving a Differentiated Services Code Point (DSCP) value associated with an outer IP packet;
encapsulating said received IP packet into said outer IP packet, said outer IP packet comprising an IP header and an Encapsulating Security Payload (ESP) header;
inserting said DSCP value into said IP header of said outer IP packet;
deriving a Traffic Class from said DSCP value and said SA;
incrementing a Sequence Number (SN) dedicated for said Traffic Class within said SA; and
inserting said incremented SN and said Traffic Class into said outer IP packet.

2. The method according to claim 1, wherein said inserting comprises inserting said incremented SN and said Traffic Class in said ESP header of said outer IP packet.

3. The method according o claim 2, wherein said Traffic Class is inserted into one of:
said ESP header in a part of a Security Parameter Index (SPI) field of said ESP header;
said ESP header in a part of one of an SN field or an Extended Sequence Number (ESN) field of said ESP header; or
said ESP header in a dedicated field of the ESP header.

4. A method in a receiving node of communicating data over an Internet protocol, IP, network employing Internet security, the method comprising:
receiving an IP packet, comprising an Encapsulating Security Payload (ESP), header;
deriving a Security Association (SA) and a Traffic Class, associated with said received IP packet, said Traffic Class being derived from said ESP header;
maintaining one anti-replay window for each Traffic Class within said SA;
determining if a Sequence Number (SN) in said ESP header is within said anti-replay window of said Traffic Class and is not a duplicate of an earlier received packet; and
processing the received IP packet if said SN is within said anti-replay window and is not a duplicate of an earlier received packet.

5. The method according to claim 4, further comprising dropping said received IP packet if said SN of said ESP header is not within said anti-replay window of said Traffic Class or is a duplicate of an earlier received packet.

6. The method according to claim 4, wherein said Traffic Class is derived from one of:
a part of a Security Parameter Index (SPI) field of said ESP header;
a part of one of an SN field or an Extended Sequence Number (ESN) field of said ESP header; or
a dedicated field of the ESP header.

7. A transmitting node, in an IP network employing Internet security, comprising:
a Receiving Unit adapted to receive an IP packet, to be transmitted over said IP network;
a Processing Unit adapted to:
(a) derive a Security Association (SA) associated with said received IP packet and a Differentiated Services Code Point (DSCP) value associated with an outer IP packet;
(b) encapsulate said received IP packet into said outer IP packet, said outer IP packet comprising an IP header and an Encapsulating Security Payload (ESP) header;
(c) insert said DSCP value into said IP header of said outer IP packet;
(d) derive a Traffic Class from said DSCP value and said SA;
(e) increment a Sequence Number (SN) dedicated for said Traffic Class within said SA; and
(f) insert said incremented SN and said Traffic Class into said outer IP packet; and
a Transmitting Unit adapted to transmit said outer IP packet towards a destination receiving node.

8. The transmitting node according to claim 7, wherein said Processing Unit is adapted to insert said incremented SN and said Traffic Class in said ESP header of said outer IP packet.

9. The transmitting node according to claim 8, wherein said Processing Unit is adapted to insert said Traffic Class into one of:
a part of a Security Parameter Index (SPI) field of said ESP header;
a part of one of an SN field or an Extended Sequence Number (ESN) field of said ESP header; or
a dedicated field of the ESP header.

10. A receiving node, in an IP network employing Internet security, comprising:
a Receiving Unit adapted to receive an IP packet comprising an ESP header;
a Processing Unit adapted to:
(a) derive a Security Association (SA) and to derive a Traffic Class associated with said received IP packet from said ESP header;
(b) maintain one anti-replay window for each Traffic Class within said SA;
(c) determine if a sequence number in said ESP header is within said anti-replay window of said Traffic Class and is not a duplicate of an earlier received packet; and
(d) processing the received packet if said sequence number is within said anti-replay window and is not a duplicate of an earlier received packet; and
a Transmitting Unit adapted to forwarding an encapsulated IP packet (830) comprised within said received IP packet to its destination as indicated in an IP header of said encapsulated IP packet.

11. The receiving node according to claim 10, wherein said Processing Unit is adapted to, if said Sequence Number (SN) of said ESP header is not within said anti-replay window of said Traffic Class or is a duplicate of an earlier received packet, drop said received packet.

12. The receiving node according to claim 10, wherein said Processing Unit is adapted to derive said Traffic Class from one of:
a part of a Security Parameter Index (SPI) field of said ESP header;
a part of one of an SN field or an Extended Sequence Number (ESN) field of said ESP header;
a dedicated field of the ESP header.

13. A computer-readable medium comprising a computer program having program instructions stored thereon that are executable by a processing unit to cause a transmitting node to perform the method of claim 1.

14. A computer-readable medium comprising a computer program having program instructions stored thereon that are executable by a processing unit to cause a receiving node to perform the method of claim 4.
